(19) United States
(12) Patent Application Publication
(10) Pub. No.: US 2022/0340103 A1
(43) Pub. Date: Oct. 27, 2022

(54) Device for Cleaning a Support Member Covered with a Liquid

(71) Applicants: UNIVERSITE DE LILLE, LILLE (FR); CENTRALE LILLE INSTITUT, VILLENEUVE D'ASCQ CEDEX (FR); UNIVERSITE POLYTECHNIQUE HAUTS-DE-FRANCE, VALENCIENNES (FR); CENTRE NATIONAL DE LA RECHERCHE SCIENTIFIQUE, PARIS (FR); YNCREA HAUTS DE FRANCE, LILLE (FR); VALEO SYSTEMES D'ESSUYAGE, LE MENSIL SAINT DENIS (FR)

(72) Inventors: Adrien PERET, ISSOIRE (FR); Frederic BRETAGNOL, ISSOIRE (FR); Michaël BAUDOIN, VILLENEUVE D'ASCQ CEDEX (FR); Olivier BOU MATAR-LACAZE, VILLENEUVE D'ASCQ CEDEX (FR)

(21) Appl. No.: 17/763,020

(22) PCT Filed: Sep. 24, 2020
(86) PCT No.: PCT/EP2020/076758

§ 371 Date: Mar. 23, 2022

(30) Foreign Application Priority Data
Sep. 25, 2019 (FR) FR1910589

(51) Int. Cl. B60S 1/02; B08B 7/02; B06B 1/06; B08B 17/02; B60S 1/56

(52) U.S. Cl. CPC B60S 1/02; B08B 7/028; B06B 1/0622; B08B 17/02; B60S 1/56

(57) ABSTRACT

Device for cleaning a support member covered with a liquid Electroacoustic device (10) comprising:—a support member (50),—at least two wave transducers (15a-h) which are acoustically coupled to the support member and each configured to generate an ultrasonic surface wave (Wa-h) which propagates in the support member, the propagation directions (P) of the ultrasonic surface waves generated by the transducers being different;—a control unit (40), the device comprising an analysis unit (35) which is configured to estimate the orientation of the external force (OFe) which is applied to a liquid when the liquid is in contact with the support member and/or the device being configured to receive the estimate of the orientation of the external force, the control unit being configured to control at least one of the transducers, from the estimate of the orientation of the external force, so that the acoustic force which is applied to the liquid and produced by the interaction between the ultrasonic surface wave(s) and the liquid is orientated in a predetermined direction.

The present invention relates to a method for displacing a liquid, in particular a drop, a puddle or a film of liquid, on a support, in particular in motion, by means of an ultrasonic surface wave.

In various fields, it is necessary to overcome the effects related to the build-up of a liquid on a surface.

It is known practice to rotate the drops of a liquid in order to remove them from a surface. However, such a technique is not suitable for surfaces whose area is larger than a few square centimeters.

The implementation of an electric field to control hydrophobicity of a surface is also known, for example from KR 2018 0086173 A1. This technique, known by the acronym EWOD (for electrowetting on devices) consists in applying a difference in potential between two electrodes, so as to electrically polarize the surface in order to make it hydrophilic, thereby debonding the drop from the surface. By controlling the location of the polarization, the drop can then be displaced. However, this technique can be implemented only with particular materials and requires particularly precise positioning of the electrodes over the entire surface where it is desired to control the wetting properties.

It is also well-known practice to apply a mechanical force to the liquid, for example using a windshield wiper on a windshield of a motor vehicle. However, a windshield wiper limits the field of view accessible to the driver. It also spreads greasy particles deposited on the surface of the windshield. In addition, the wiper trim needs to be renewed regularly.

Furthermore, autonomous motor vehicles have a large number of sensors in order to determine the distances from and speeds of other vehicles present on the road. Such sensors, for example lidars, are also subject to bad weather and mud splash and require frequent cleaning. However, a wiper is unsuitable for cleaning the small area of such a sensor.

Methods for removing a liquid accumulating on a support are known which involve the generation of ultrasonic surface waves and propagation thereof through the support. In particular, WO 2012/095643 A1 describes a method for removing raindrops from a windshield through ultrasonic vaporization. The amplitude and frequency of vibration are chosen so that raindrops falling on the windshield are vaporized as soon as they enter the zone of vibratory movement of the surface of the windshield. However, in order to vaporize a drop of liquid, a puddle or a film, the power levels required to vibrate a support are high, which limits their practical implementation, in particular for the development of autonomous devices. it is also well known that vaporization requires energy levels higher than those requested to displace drops on a support.

There is still a need to improve the removal of a liquid from a support. coated by the liquid.

The invention aims to satisfy this need, and it achieves this by proposing an electroacoustic device comprising:
a support,
at least two wave transducers acoustically coupled to the support and each being configured to generate an ultrasonic surface wave which propagates through the support, the directions of propagation of the ultrasonic surface waves generated by the transducers being different,
a control unit,
   the device comprising an analysis unit configured to estimate the orientation of the external force being applied to a liquid, when the liquid is in contact with the support, and/or the device being configured to receive the estimate of the orientation of the external force, the control unit being configured to control at least one of the transducers, on the basis of the estimate of the orientation of the external force, so that the acoustic force being applied to the liquid, produced by the interaction between the one or more ultrasonic surface waves and the liquid, is oriented in a predetermined sense.

The invention facilitates the displacement of the liquid on the support by combining the effect of the external force and the effect of the acoustic force.

What is meant by “external force” is any force other than the acoustic force. The weight of the liquid or an aerodynamic force caused by the flow of a fluid over the liquid are examples of external force.

A person skilled in the art is easily able to determine the orientation of the acoustic force being applied to a liquid arranged on a support, which is caused by a surface wave generated by a transducer. In the case of a plane surface wave, the acoustic force is oriented along the wave vector associated with the plane wave. In the case of a focused surface wave, the liquid is displaced toward the focal point of the transducer. The effects at the origin of the displacement of the liquid may be non-linear. The acoustic force may therefore be substantially proportional to the intensity of the radiated acoustic wave and to the strength of the electric current supplying the transducer with power.

The control unit may comprise in particular:
a storage module, for example a flash memory in which are recorded, for example in the form of a table, said set of orientations of the acoustic forces and the associated characteristics of the electric currents for controlling the transducers, and
a synthesis module configured to compare the estimated orientation of the external force with the set of orientations of the acoustic forces recorded in the module and to supply the transducers with the associated electric control currents.

Preferably, the control unit is configured to control the one or more transducers so as to minimize the angle between the orientation of the acoustic force projected onto the support and the estimated orientation of the external force projected onto the support, in order to facilitate the displacement of the liquid on the support. The removal of the liquid from the face of the support is thus accelerated.

The control unit may be configured to choose those transducers which generate an ultrasonic surface wave oriented in a sense close to the external force projected onto the support, What is meant by “close sense” is that the angle between the direction of the external force and the sense of propagation of the wave is smaller than 90°, or even smaller than 45°. The control unit may be configured to control each of the transducers thus chosen such that the acoustic energy of the wave generated by the corresponding transducer is proportional to the angle between the external force projected onto the support and the sense of propagation of the wave.

Preferably, the control unit is configured to control the one or more transducers so that the orientation of the acoustic force projected onto the support is substantially parallel to the orientation of the external force projected onto the support.

The control unit may comprise a plurality of switches each configured to electrically open or close an electrical power supply circuit for a corresponding transducer.

The control unit may comprise an electrical amplification device configured to amplify an electric current being supplied to one of the transducers. In particular, the control unit may be configured so that at least two of the transducers generate surface ultrasound. waves of different amplitudes.

In order to ensure optimal displacement of the liquid on the surface of the support, the fundamental frequency of the ultrasonic surface wave generated by at least one of the transducers, or even by each of the transducers, is preferably between 0.1 MHz and 1000 MHz, preferably between 10 MHz and 100 MHz, for example equal to 40 MHz.

The amplitude of the surface ultrasonic wave generated by at least one of the transducers, or even by each of the transducers, may be between 1 picometer and 500 nanometers. It may in particular depend on the fundamental frequency of the wave. It corresponds to the normal displacement of the face of the support over which the ultrasonic surface wave propagates and may be measured using laser interferometry.

The ultrasonic surface wave may be a Rayleigh wave or a Lamb wave. In particular, it may be a Rayleigh wave when the support has a thickness greater than the wavelength of the ultrasonic surface wave. A Rayleigh wave is favored because the energy of the wave is concentrated on the face of the support over which it propagates, and may thus be transmitted efficiently to the liquid.

The analysis unit is configured to estimate, when a liquid is arranged on the support, the orientation of the external force being applied to the liquid.

Preferably, the device comprises a measurement unit connected to the analysis unit and configured to measure at least one physical quantity. It is configured to receive the physical quantity, in particular with a frequency higher than 1 Hz, or even higher than 10 Hz, for example equal to 50 Hz.

The physical quantity may characterize the support. For example, the physical quantity may be chosen from among the speed of the support with respect to a frame of reference and the position and/or the orientation of the support in a frame of reference. For example, the physical quantity is the speed of a motor vehicle comprising the electroacoustic device.

The frame of reference may be an absolute frame of reference. What is meant by an “absolute frame of reference” is a geodesic frame of reference in which the location of an object on Earth may be defined unequivocally. The absolute frame of reference may be chosen from the following: Réseau Géodésique Franc̨ais 1993 (RGF93), World Geodetic System (WGSS4), international Terrestrial Rotational Service (ITIS) and European Terrestrial Reference System (ETRS).

The measurement unit may be connected to the analysis unit by means of an electrical cable. As one variant, the connection between the measurement unit and the analysis unit may be made by a link via electromagnetic waves.

The electroacoustic device may include the measurement unit. According to another variant, the measurement unit may be remote from the device.

For example, the support is a surface of a motor vehicle, and the measurement unit is arranged in the gearbox and is configured to convert the motor/engine shaft speed into the vehicle speed, or is arranged in a wheel of the vehicle and is configured to measure the rotational speed of the wheel and convert it into the speed of the vehicle.

The measurement unit may be a OPS transceiver configured to measure the position and/or the orientation of the support.

The physical quantity may characterize the liquid. For example, it may be the area of the liquid covering the support or the thickness of the liquid.

It may also characterize the environment of the support. For example, when the support is mobile in a frame of reference, the physical quantity may be the speed of a fluid, for example air, flowing around the support. A measurement unit able to measure the speed of the fluid is, for example, a Pitot probe or a MEMS sensor which may be mounted on the support.

Preferably, the device comprises a plurality of measurement units as described above.

Furthermore, in order to improve the estimate of the orientation of the external force, the device may comprise a communication module configured to communicate with a remote data server and to receive meteorological information from the data server, for example the average speed and/or the average direction of the wind, relative to the position and/or to the orientation of the support. The communication module may in particular comprise a telecommunication means, in particular cellular telecommunication means, for communicating with the data server.

Preferably, the analysis unit is configured to estimate the orientation of the external force by means of a numerical estimation model that takes, as input data, the physical quantity, the orientation of the support with respect to the horizontal and, optionally, the meteorological information provided by the communication module.

As one variant or additionally, the communication module may be configured to communicate with at least one other remote device which is provided with an analysis unit configured to estimate the orientation of the external force being applied to the liquid, the communication module being further configured to receive the estimate of the orientation of the external force from the analysis unit of the other device.

The device and the other device may be more than 1 m apart, or even more than 5 m and/or less than 1 km, or even less than 100 m.

For example, the device is mounted on one motor vehicle and the other device is mounted on another motor vehicle. The vehicles may follow a common path and the device mounted on the vehicle upstream on the path may transmit the estimate of the external force to the device mounted on the vehicle downstream.

A person skilled in the art knows how to develop such an estimation model as a matter of routine. For example, in one variant where the support is borne by a vehicle or is a surface of a vehicle, the person skilled in the art may determine the air flow trajectories in various regions of the envelope of a vehicle moving at a determined speed, on the basis of an aerodynamic test in a wind tunnel. They may also determine the local speed of the air flow in each of said regions, and thus calculate an estimate of the force applied to the liquid in each of the regions.

For example, the analysis unit may estimate the orientation of the external force applied to a liquid, for example raindrops, on the external face of a support such as a windshield or a protective member for a sensor of a vehicle, from the measurement of the speed of the vehicle, the orientation of the vehicle transmitted by a UPS transceiver, and the average speed and the average direction of the wind obtained from the data server.

The displacement of the liquid caused by the ultrasonic surface wave may in particular result from an acoustic streaming effect and/or from a radiation pressure effect caused by the one or more ultrasonic surface waves.

The liquid may take the form of at least one drop, or the form of a plurality of drops which may have different sizes. The liquid may take the form of at least one film, which may be continuous or discontinuous. What is meant by “film” is a thin film formed on the support. The liquid may take the form of a puddle.

The liquid may be aqueous. In particular, it may be rainwater or dewwater. Rainwater and/or dewwater may in particular contain greasy particles. Dewwater forms a mist on the surface of a support. It results from condensation on the support, under suitable pressure and temperature conditions, of water held in the air in the form of vapor.

The device may comprise a detection unit configured to detect the presence of the liquid on the support. For example, the detection unit may be configured to process a stream of images acquired by a camera and to detect when the camera is blinded by liquid. The detection unit may be configured to process an information stream from a LiDAR in order to detect the decrease in LiDAR range caused by the liquid.

Furthermore, the detection unit may be configured to measure and analyze a surface wave emitted by at least one of the transducers in order to detect the presence of the liquid in contact with the support. For example, the detection unit may be configured to measure the wave transmitted between two of the transducers arranged opposite one another on the support. According to another example, the device may be configured so that one of the transducers generates an ultrasonic wave in the form of a pulse, for example a squarewave or Dirac pulse, and to measure whether a response wave is produced through interaction between the liquid and the pulse, if the liquid is in contact with the support.

Lastly, the surface wave transducers may themselves be used to detect the presence of liquid on the support, either by measuring the transmission of the signal between two transducers located facing one another, or by sending pulses and measuring the echo generated by the reflection of the wave by the liquid.

The support may be made of any material capable of propagating an ultrasonic surface wave. Preferably, it is made of a material for which the absorption length for the ultrasonic surface wave in the material is at least more than 10 times, or even at least more than 100 times, greater than the area of the support.

The face of the support over which the longitudinal surface wave propagates may be planar. It may also be curved, provided that the radius of curvature of the face is larger than the wavelength of the ultrasonic surface wave.

The face may be rough. It may have a roughness Ra lower than the wavelength. The support may in particular take the form of a flat plate, or a plate having at least one curvature in a certain direction. The thickness of the plate may be smaller than 10 cm, or smaller than 1 cm, or even smaller than 1 nm. The length of the plate may be longer than 1 cm, or longer than 10 m, or even longer than 1 m.

What is meant by “thickness of the support” is the smallest dimension of the support measured in a direction perpendicular to the surface over which the ultrasonic wave propagates.

The support may be arranged flat with respect to the horizontal. As one variant, it may be inclined with respect to the horizontal by an angle a larger than 10°, or larger than 20°, or even larger than 45°, or even larger than 70°. It may be arranged vertically.

The support may be optically transparent, in particular to light in the visible range. The method is thus then particularly suitable for applications in which improvement in the visual comfort of a user observing their environment through the support is sought.

The support may be made of a material chosen from among piezoelectric materials, polymers, in particular thermoplastics, in particular polycarbonate, glasses, metals and ceramics.

Preferably, the support is made of a material other than a piezoelectric material.

Preferably the support is chosen from the group formed by:
a motor vehicle surface, for example chosen from among a windshield of a vehicle, or a glazing of a rear view mirror, or
a visor of a helmet,
a window of a building,
a surface of an optical device, for example chosen from among a lens of a camera, a lens of spectacles and a sensor, in particular a probe, for example a Pitot probe or a lidar, and
a protective element for such a sensor.

The support may be a structural element of an aircraft, for example a wing, a fuselage or an empennage.

The device comprises at least two transducers. In order to define the orientation of the acoustic force even more precisely, the device preferably comprises at least three, or even at least four, better still at least eight wave transducers, preferably distributed regularly around an axis normal to one face of the medium.

Preferably, the device comprises at least two, or even at least three, better still at least four pairs of transducers, the transducers of one and the same pair being arranged so as to generate ultrasonic surface waves that propagate in the same direction but in different senses. Preferably, the transducers of one and the same pair are arranged facing one another in the direction of propagation of the waves that they may generate.

The device may have an even number of transducers.

The transducers may be attached, and preferably bonded, to the support. in particular, they may be arranged on an edge of the support.

The transducers may at least partially cover the support, in particular the face of the support on which the liquid rests.

At least one of the transducers, or even each of the transducers, may directly generate the ultrasonic surface wave. Alternatively, at least one of the transducers, or even each of the transducers:, may generate an ultrasonic guided wave, which propagates at the interface between the support and the transducer, and then transforms into the ultrasonic surface wave along a portion of the support arranged at a distance from said transducer.

At least one of the transducers, or even each transducer, may be in direct contact with the support or with an intermediate layer, for example formed of adhesive, arranged on the support.

Preferably, at least one of the transducers, preferably each transducer, comprises first and second electrodes forming first and second combs, respectively, the first and second combs being interdigitated and being arranged on the support and/or arranged in direct contact with the support and/or in contact with an intermediate substrate in contact with, in particular arranged on, the support, the substrate being made of a piezoelectric material.

The piezoelectric material may be chosen from the group formed by lithium niobate, aluminum nitride, lead zirconate titanate, zinc oxide, and mixtures thereof. The piezoelectric material may be opaque to light in the visible range.

As one variant, the support is formed from the piezoelectric material and at least one of the transducers includes the support. The first and second combs are then preferably arranged in contact with the support,

As another variant, the support is made of a material other than a piezoelectric material and the electrodes are arranged on the intermediate substrate.

The first and second electrodes may be deposited on the support and/or on the substrate using photolithography.

The first and second electrodes may be sandwiched between the support and the substrate, which preferably has a thickness at least once, or even at least twice, greater than the fundamental wavelength of the ultrasonic guided wave. Alternatively, the substrate may be sandwiched between the support and the first and second electrodes, and preferably has a thickness smaller than the fundamental wavelength of the ultrasonic guided wave.

The first and second combs may preferably include a base from which extends a row of fingers, the fingers preferably being parallel to one another. The fingers may have a width of between one eighth of the wavelength of the ultrasonic surface wave and half of said wavelength, preferably equal to one quarter of said wavelength. The width of the fingers partly determines the fundamental frequency of the ultrasonic surface wave.

Furthermore, the spacing between two consecutively adjacent fingers of a row of the first comb or of the second comb, respectively, may be between one eighth of the wavelength of the ultrasonic surface wave and half of said wavelength, preferably equal to a quarter of said wavelength.

The row of fingers of the first comb and/or the row of fingers of the second comb may each comprise more than two fingers, or even more than 10 fingers, or even more than 40 fingers. Increasing the number of fingers increases the quality factor of the transducer.

The substrate may be a thin layer deposited, for example, by chemical vapor deposition or by sputtering on the support. As one variant, the substrate may be self-supporting, that is to say rigid enough not to bend under its own weight. The self-supporting substrate may be attached, for example bonded, to the support.

The portion of the liquid farthest from the transducer may be arranged at a distance corresponding to several times the attenuation length of the surface wave in the support.

Furthermore, the device may include an electric generator, for example a battery, in order to supply each transducer with power. The generator may be connected to the control unit. It may supply the analysis unit with power.

The electric generator may deliver to at least one of the transducers, or even to each of the transducers, a power of between 10 milliwatts and 50 watts.

Lastly, the invention also relates to a motor vehicle chosen from among a car, a bus, a motorcycle and a truck, the vehicle comprising a device according to the invention.

Preferably, the vehicle comprises a chassis and the device is fixed with respect to the chassis.

The invention also relates to a method comprising providing a device, in particular one according to the invention, comprising a surface covered by a liquid and at least two wave transducers acoustically coupled to the support and each being configured to generate an ultrasonic surface wave which propagates through the support, the directions of propagation of the ultrasonic surface waves generated by the transducers being different,

the method comprising estimating the orientation of the external three being applied to the liquid and, on the basis of said estimate, supplying at least one of the transducers with power in order to propagate one or more ultrasonic surface waves through the support so that the acoustic force being applied to the liquid, produced by the interaction between the one or more ultrasonic surface waves and the liquid, is oriented in a predetermined sense.

Preferably, the device is mounted on a motor vehicle and the estimate of the external force includes the measurement of the speed of the vehicle.

Lastly, the invention relates to a motor vehicle comprising a vehicle speed sensor and an electroacoustic device, in particular according to the invention, comprising:
a support.,
at least two wave transducers acoustically coupled to the support and each being configured. to generate an ultrasonic surface wave which propagates through the support, the directions of propagation of the ultrasonic surface waves generated by the transducers being different, and
a control unit configured to control, by means of the speed of the vehicle, at least one of the transducers so that, when a liquid is arranged on the support, the acoustic force being applied to the liquid, produced by the interaction between the one or more ultrasonic surface waves and the liquid, is oriented in a predetermined sense.

The invention will possibly be better understood on reading the following detailed description of non-limiting examples of implementation thereof, and on examining the appended drawing, in which:

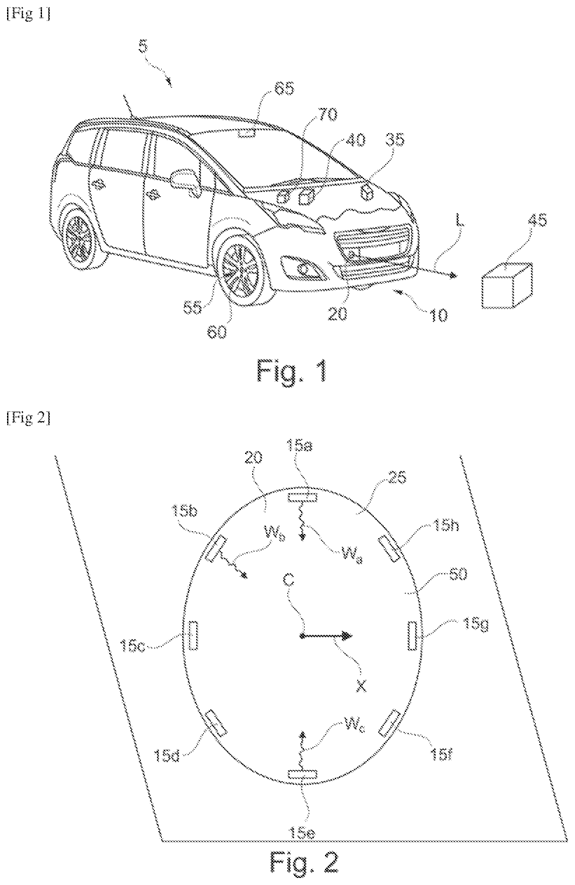

FIG. 1 shows, in a perspective view, a motor vehicle comprising one example of a device according to the invention,

FIG. 2 is a close-up of FIG. 1 showing a portion of the device according to the invention,

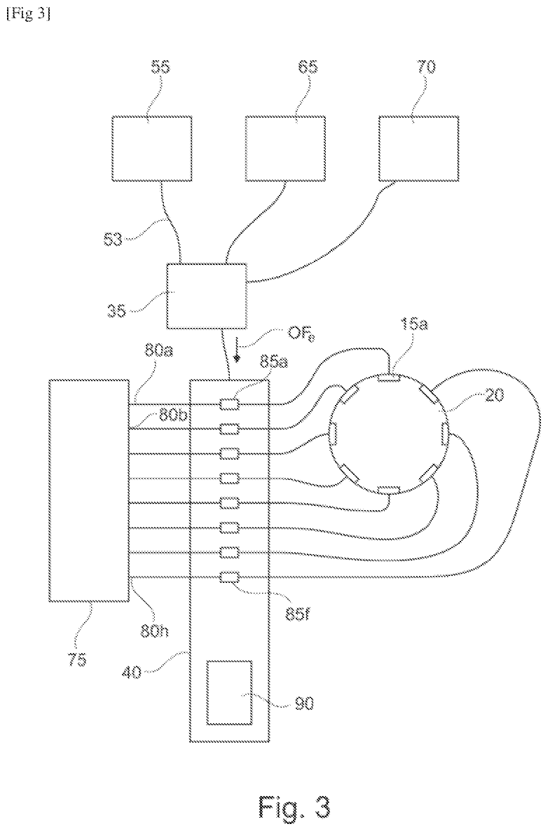

FIG. 3 is a schematic representation of the device from example 1,

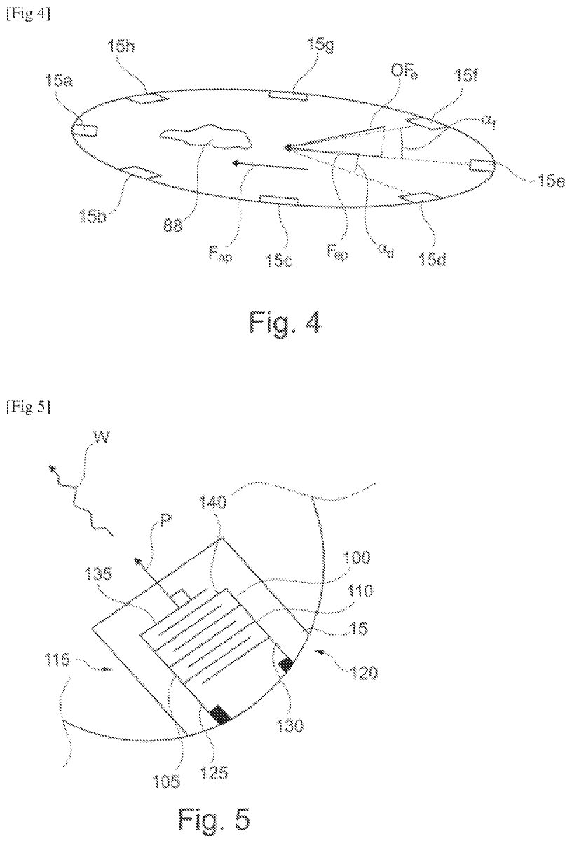

FIG. 4 illustrates one example of a method for choosing which transducers to activate,

FIG. 5 shows one embodiment of a transducer front an exemplary device, and

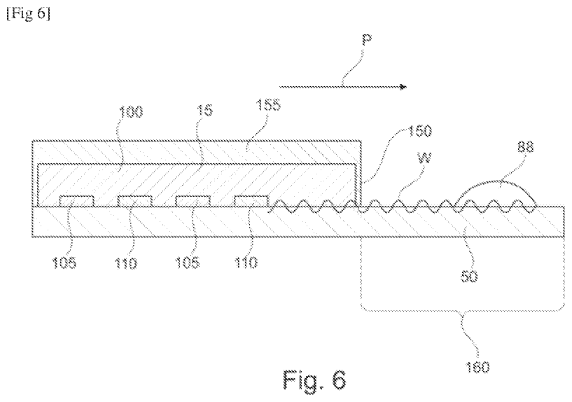

FIG. 6 shows another embodiment of a transducer from an exemplary device.

The constituent elements of the drawing are not shown to scale for the sake of clarity.

FIG. 1 shows a motor vehicle 5 containing one example of a device 10 according to the invention.

The device comprises a plurality of ultrasonic surface wave transducers 15a-h and a support 20, defined by a porthole mounted in a window 25 made in a protective casing 30 for a lidar, on which the transducers are arranged. The device further comprises an analysis unit 35 and a control unit 40 for the transducers, both housed in the vehicle.

The porthole is transparent to visible light and is, for example, made of glass or polycarbonate.

A lidar is housed in the protective casing and emits a laser beam L through the porthole in order to detect obstacles 45, pedestrians and other vehicles located in the vehicle's environment. In the example illustrated, the porthole is planar, but as one variant, it may be curved.

The transducers are arranged on the periphery of the outer face 50 of the porthole, exposed to the wind and the rain. They are moreover arranged in a regular manner around the axis X which passes through the center C of the porthole and which is perpendicular to the face. Thus, the transducers, for example referenced 15ₐ and 15ₑ, arranged symmetrically with respect to the center, form pairs, each transducer of a pair emitting an ultrasonic surface wave, for example Wa, in an opposite sense to the sense of the wave, for example We, emitted by the transducer of the other pair.

In the example illustrated in FIG. 1, each transducer is configured to propagate an ultrasonic surface wave Wₐ₋ₑ oriented substantially toward the center C. Thus, whatever the estimated orientation of the external force projected onto the support, at least one of the transducers of the device can be controlled so as to generate a surface wave capable of producing an acoustic force whose component projected onto the support is oriented. substantially parallel to the projected external force.

Of course, other arrangements of the transducers may be envisaged. Likewise, the number of transducers is not limiting, and may be decreased or increased.

The analysis unit is housed in the vehicle, for example under the front hood or in the passenger compartment. It is connected by means of electrical cables 53 to a vehicle speed measurement unit 55 arranged in a wheel 60 of the vehicle and is configured to measure the rotational speed of the wheel and convert it into the speed of the vehicle. The analysis unit is also connected to a GPS transceiver 65 which measures the position and orientation of the vehicle, and which may also estimate the speed of the vehicle.

Thus, according to a predetermined frequency of acquisition, for example higher than 1 Hz, or even higher than 10 Hz, for example equal to 50 Hz, the analysis unit can receive the speed, the orientation and the position of the vehicle.

Furthermore, the analysis unit is connected to a cellular communication module 70 in order to interrogate a remote meteorological data server and to receive from the server the direction and the speed of the wind, with respect to the position of the vehicle.

The analysis unit estimates the orientation of the external force by means of a numerical estimation model that takes, as input data, the speed, the position and the orientation of the vehicle and the meteorological information. The estimation model also takes into account the position of the porthole with respect to the horizontal in order to estimate the component related to the weight of the liquid.

Thus, when a liquid 88 is detected on the face of the porthole, for example in rainy weather, the analysis unit can estimate the orientation OFₑ of the external force and transmit it to the control unit 40. The control unit is electrically connected to the analysis unit and to a multichannel current generator 75. Each channel 80a-h of the current generator is electrically connected to a corresponding transducer 15a-h in order to provide the transducer with power. The control unit further comprises a plurality of switches 85a-h, each electrically arranged between the current generator and the transducer.

The control unit further comprises a synthesis module 90. The synthesis module chooses, from among the set of transducers of the device, those transducers which generate an ultrasonic surface wave that has an angle a of less than 90° with respect to the orientation of the external force OFₑₚ projected onto the support. For example, in FIG. 3, the transducers 15d, 15ₑ and 15f are chosen because they have angles α_{d-f} of less than 90°. The control unit then places the switches of the electrical power supply circuits for the chosen transducers in the open position and the other switches in the closed position. It then controls the current generator so that the strength of the current transmitted to each of the chosen transducers is proportional to the angle α. Thus, the acoustic force generated by the interaction between the acoustic waves of the chosen transducers and the liquid, projected onto the support OFₐₚ, is substantially parallel and oriented in the same sense as the external force projected onto the support. The liquid is then subjected to a force of higher strength than the external force alone, which facilitates the debonding and displacement thereof with respect to the support

FIG. 5 illustrates one exemplary arrangement of one of the transducers on the support from the example shown in FIG. 1.

The transducer comprises a substrate 100 on which are arranged first 105 and second 110 electrodes. The substrate is, for example, made of lithium niohate cut at 128°.

The electrodes are deposited using photolithography. They consist of a tie layer for attachment to the intermediate substrate formed of titanium and with a thickness equal to 20 nm and of a conductive layer of gold with a thickness of 100 nm.

The first and second electrodes form first 115 and second 120 combs. Each comb has a base 125, 130 and a row of fingers 135, 140 extending parallel to one another from the base. The first and second combs are interdigitated.

The spacing between the fingers determines the resonant frequency of the transducer, which a person skilled in the art readily knows how to determine.

The powering of the first and second electrodes in alternation induces a mechanical response in the piezoelectric material arranged between two consecutive fingers of the first and second combs, which results in the generation of an ultrasonic surface wave W which propagates through the support in a sense of propagation P, perpendicular to the fingers of the first and second combs.

FIG. 6 illustrates another arrangement of the transducers on the support.

The transducer comprises a self-supporting substrate 100 and the first 105 and second 110 electrodes are deposited on the face of the substrate 50 bonded to the support 100. When an electric current passes through the first and second electrodes, the transducer generates an ultrasonic guided wave G, which propagates between the support and the substrate. When the guided wave reaches the end 150 of the substrate along its direction of propagation, it is transformed into an ultrasonic surface wave W which propagates through the portion 160 of the support separate from the substrate, substantially in the same direction of propagation as the guided wave. The transformation of the guided wave into a surface wave is brought about by the absence of an interface between two solids in the portion of the support.

The arrangement of the transducer illustrated in FIG. 6 has the advantage of protecting the first and second electrodes. For example, the liquid 88 cannot flow over the electrodes and oxidize them. Furthermore, optionally, the device illustrated in FIG. 4 may comprise a protective member 155 which defines, together with the support, a housing for the transducer. This prevents objects striking the device from damaging the transducer.

Obviously, the invention is not limited to the embodiments and examples presented by way of illustration.

1.-15. (caneled)

16. An electroacoustic device comprising:
a support, w
ave transducers acoustically coupled to the support and configured to generate ultrasonic surface waves that propagate through the support in different respective directions;
an analysis unit configured to estimate a direction of an external force applied to a liquid disposed on the support; and
a control unit configured to control the transducers, based on the estimated direction of the external force, such that a direction of an acoustic force applied to the liquid by one or more of the ultrasonic surface waves is oriented at an angle with respect to the estimated direction of the external force.

17. The device of claim 16, wherein the control unit is configured to control the transducers so as to minimize the angle between the direction of the acoustic force and the estimated direction of the external force, in order to maximize displacement of the liquid on the support.

18. The device of claim 16, further comprising a measurement unit connected to the analysis unit and configured to measure a speed of the support with respect to a given frame of reference, a position and/or orientation of the support with respect to a given frame of reference, or a combination thereof.

19. The device of claim 16, comprising a communication module configured to receive meteorological information from a remote data server. Pcm 20. The device of claim 18, wherein the analysis unit is configured to estimate the direction of the external force using a numerical estimation model that is based on measurements taken by the measurement unit, meteorological information, or a combination thereof.

21. The device of claim 16, comprising a communication module configured to receive an estimate of the direction of the external force from a remote device.

22. The device of claim 16, wherein the device comprises at least three wave transducers.

23. The device of claim 16, wherein a fundamental frequency of the ultrasonic surface waves generated by at least one of the transducers is between 0.1 MHz and 1000 MHz.

24. The device of claim 16, the support is transparent or translucent.

25. The device of claim 16, wherein the support comprises a material chosen from piezoelectric materials, polymers, glasses, metals, or ceramics.

26. The device of claim 16, wherein the support comprises:
a motor vehicle surface;
a visor of a head set;
a window of a building;
a sensor;
a lens of an optical device; or
a protective element of an optical device.

27. The device of claim 16, wherein:
the transducer comprises interdigitated electrodes that directly contact the support; and
the support comprises a piezoelectric material.

28. The device of claim 16, wherein:
the transducer comprises interdigitated electrodes disposed on the support; and
the device comprises a piezoelectric layer disposed between the interdigitated electrodes and the support.

29. The device of claim 16, wherein the control unit is configured to control the transducers, such that the direction of the acoustic force is parallel to the estimated direction of the external force.

30. The device of claim 16, wherein the acoustic force is generated by an interaction of all of the ultrasonic surface waves.

31. A motor vehicle comprising the device of claim 16.

32. The motor vehicle of claim 31, wherein the motor vehicle comprises a car, a bus, a motorcycle, or a truck.

33. A motor vehicle comprising a vehicle speed sensor and an electroacoustic device comprising:
a support;
wave transducers acoustically coupled to the support and configured to generate ultrasonic surface waves that propagate through the support in different respective directions;
an analysis unit configured to estimate an external force applied to a liquid disposed on the support, based on a speed of the vehicle detected by the vehicle speed sensor; and
a control unit configured to control the transducers, based on the estimated external force, such that an acoustic force applied to the liquid by one or more of the ultrasonic surface waves is oriented in a corresponding predetermined direction.

34. The motor vehicle of claim 33, wherein the control unit is configured to control the transducers, such that a direction of the acoustic force is parallel to a direction of the external force.

35. The motor vehicle of claim 33, wherein the support is a windshield of the vehicle.
